(19) United States
(12) Patent Application Publication
(10) Pub. No.: US 2008/0214404 A1
(43) Pub. Date: Sep. 4, 2008

(54) Functional molecule binding specifically to membrane protein, and manufacturing method therefor

(75) Inventors: Tomoyasu Kichise, Kawasaki (JP); Tsuyoshi Fujihara, Kawasaki (JP); Shozo Fujita, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 12/071,336

(22) Filed: Feb. 20, 2008

(30) Foreign Application Priority Data
Feb. 21, 2007 (JP) 2007-40320

(51) Int. Cl. C40B 20/08; C40B 30/04

(52) U.S. Cl. 506/6; 506/9

(57) ABSTRACT

A membrane protein is brought into contact with a pool of functional molecule candidates including a modified oligonucleotide sequence obtained by random polymerization of modified nucleotide n-mers (wherein n is an integer) having a modified nucleoside having a substituent introduced therein, then the membrane protein is treated with a protease, and the functional molecule that has bound to the membrane protein is isolated. The corresponding unmodified molecule is amplified from this function molecule, the sequence of corresponding unmodified molecules obtained by the amplification is decoded, and the decoding results are translated into the sequence of the isolated functional molecule. The functional molecule can be manufactured based on this translation.

### CROSS-REFERENCE TO RELATED APPLICATIONS

This application is based upon and claims the benefit of priority from the prior Japanese Patent Application No. 2007-40320, filed on Feb. 21, 2007, the entire contents of which are incorporated herein by reference.

### BACKGROUND OF THE INVENTION

1. Field of the Invention

The present invention relates to a functional molecule that binds specifically to a membrane protein.

2. Description of the Related Art

Membrane proteins have been targeted for new drug development, and in particular half of the drugs currently in clinical use are said to act on multiple transmembrane proteins such as G protein-coupled receptors (GPCR).

Until now, antibodies to membrane proteins and other proteins have been prepared by the conventional antibody production method or using a mouse hybridoma. In the conventional antibody production method, a rabbit is inoculated with an antigen mixed with an adjuvant, an operation that is repeated every 2 to 3 weeks for 3 months to half a year, after which whole blood is collected and used to obtain polyclonal antibodies. In the method using a mouse hybridoma, a mouse is inoculated with an antigen mixed with an adjuvant repeatedly every 2 to 3 weeks for 1 month to half a year, after which spleen cells are collected and treated with myeloma cells, the fused antibody-producing cells are selected and cloned to obtain cells which are then injected into mice, and ascites are collected and column purified to obtain monoclonal antibodies.

However, these methods have the following problems:

1. A large quantity of antigen protein (5 to 10 mg of protein) is required when using rabbits or the like. When using mice, less antigen protein is required (0.25 to 2.5 mg of protein), but only a small quantity of serum is obtained. The process also requires about 3 months from preparing the protein for the antigen to obtaining the final antibodies.

2. When the antigen is a membrane protein it is extremely difficult to refine, and it is often very difficult to ensure a sufficient quantity of protein for inoculating an individual animal as an antigen. The membrane protein used also needs to be solubilized, and once solubilized the membrane protein may become insoluble after several days, making it difficult to perform follow-up immunization for purposes of improving antibody titer.

3. About half a year is required for all the steps of establishing a hybridoma and obtaining monoclonal antibodies.

4. Membrane proteins are highly conserved among organisms, and when an animal is sensitized in an effort to obtain anti-human antibodies, antibodies often are not obtained due to immunological tolerance.

### SUMMARY OF THE INVENTION

According to an aspect of an embodiment, there is a method for preparing a functional molecule binding specifically to a membrane protein, the method including:

bringing the membrane protein into contact with a pool of functional molecule candidates including a modified oligonucleotide sequence or sequences obtained by random polymerization of modified nucleotide n-mers (wherein n is an integer) having a modified nucleoside or nucleosides having a substituent or substituents introduced therein (“a modified oligonucleotide sequence or sequences”, “a modified nucleoside or nucleosides” and “a substituent or substituents” are referred to in a singular form generically, hereinafter and in claims); and

then treating the membrane protein with a protease to isolate a functional molecule that has bound to the membrane protein.

According to another aspect of an embodiment, there is a functional molecule manufacturing method, the method including:

amplifying a corresponding unmodified molecule from a functional molecule prepared by the aforementioned functional molecule preparation method;

decoding the sequence of corresponding unmodified molecules obtained by the amplification; and

translating the decoding results into the sequence of the functional molecule.

It is desirable that such amplification be performed by any method selected from PCR, LCR, 3SR, SDA, RT-PCR, ICAN and LAMP, and that the base sequence be determined by cloning, that the manufacturing method comprises translating the sequence of corresponding unmodified molecule (the base sequence of which has been determined) into the sequence of the functional molecule based on a correspondence table in which unmodified nucleotide n-mers and modified nucleotide n-mers are matched 1:1 as represented by the sequence of n bases of the nucleosides, that this translation be performed based on this correspondence table for each n bases starting from the 5′ end of the sequence of corresponding unmodified molecules (the base sequence of which has been determined), that the modified nucleotide n-mers be modified nucleotide dimers, and that the modified nucleotide n-mers be modified nucleotide trimers.

### BRIEF DESCRIPTION OF THE DRAWINGS

FIG. 1 is a schematic diagram showing a modified oligonucleotide sequence having fixed oligonucleotide sequences at both ends;

FIG. 2 is a diagram showing synthesis of modified nucleotide dimers using a DNA sequencer;

FIG. 3 is a model cross-section of a cell wall; and

FIG. 4 is a diagram showing the process of preparing a functional molecule of the embodiments using multiple transmembrane proteins.

### DESCRIPTION OF THE PREFERRED EMBODIMENTS

Embodiments of the present invention are explained below using drawings, tables, examples and the like. These drawings, tables, examples and the like and explanations are given as examples of the present invention and do not limit its scope. Other embodiments may be included within the scope of the present invention as long as they match its intent.

The functional molecule binding specifically to a membrane protein of the present invention (a “functional molecule binding specifically to a membrane protein” may be called simply a “functional molecule” hereunder) includes a modified oligonucleotide sequence obtained by random polymerization of modified nucleotide n-mers (wherein n is an integer) containing a modified nucleoside having a substituent introduced therein. In other words, it is a modified oligonucleotide sequence obtained by random polymerization of modified nucleotide n-mers (wherein n is an integer) having a modified nucleoside having a substituent introduced therein, or a modified oligonucleotide sequence thereof, further having another structural part (such as another nucleotide sequence). It may be desirable that the “other nucleotide sequence” used be one the structure of which is known, since this can allow for more efficient amplification (replication) as discussed below. This “other nucleotide sequence” may be added to an end of a modified nucleotide n-mer, or to the middle of a modified nucleotide n-mer.

In preparing the functional molecule of the present invention, a membrane protein is brought into contact with a pool of functional molecule candidates including a modified oligonucleotide sequence obtained by random polymerization of modified nucleotide n-mers (wherein n is an integer) having a modified nucleoside having a substituent introduced therein, then the membrane protein is processed with a protease and a functional molecule that has bound to the membrane protein is then isolated.

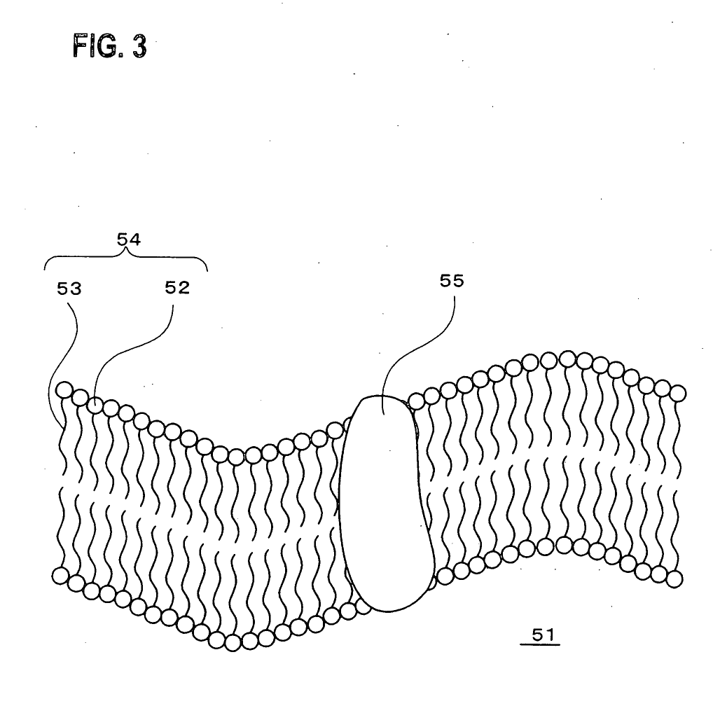

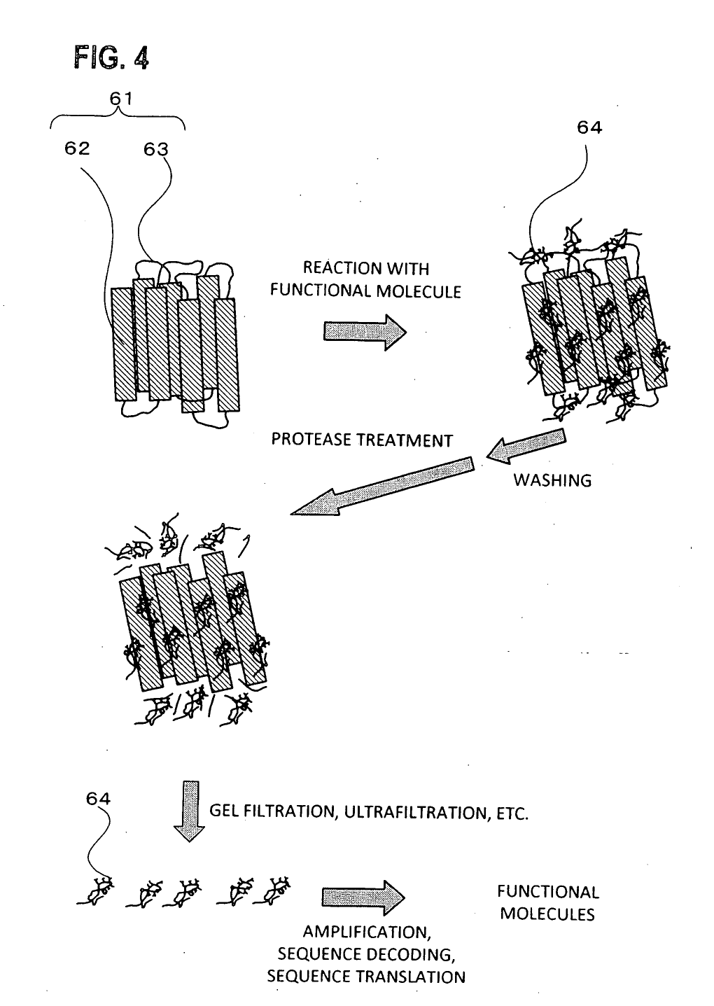

The membrane protein of the present invention may be any protein if it is either a protein embedded in the cell membrane or a protein that has been removed from the cell membrane. The membrane protein can be thought of as assuming a structure such as that schematically shown in FIG. 3, in which a membrane protein 55 protrudes its head partially like an iceberg out of a hydrophilic part 52 in a cell membrane 51, which is a double membrane of lipid 54 consisting of the hydrophilic part 52 and a hydrophobic part 53. Most membrane proteins pass through the membrane as shown by the membrane protein 55. Such transmembrane proteins include membrane proteins the hydrophilic part of which is outside the membrane, while the hydrophobic part passes through the cell membrane multiple times as shown in FIG. 4. For purposes of protease treatment, it is desirable that the membrane protein of the present invention be a membrane protein that passes through the cell membrane multiple times. To more easily obtain artificial antibodies for specific purposes, the membrane protein of the present invention is preferably one type of protein, but in many cases it may also be multiple kinds of proteins.

The term “functional” in the “functional molecule” of the present invention means that it can bind specifically to a membrane protein when brought into contact with that protein. The functional molecule of the present invention is artificially produced, and may be called an artificial antibody since it is artificial and can bind specifically to a membrane protein.

The functional molecule candidates of the present invention may be any that include a modified oligonucleotide sequence obtained by random polymerization of modified nucleotide n-mers (wherein n is an integer) having a modified nucleoside having a substituent introduced therein. The term “functional” in “functional molecule candidates” is defined as above, but the term “candidates” is used because these do not necessarily bind specifically to the membrane protein or these may include those that do not bind specifically to the membrane protein when brought into contact with the membrane protein.

However, because the functional molecule candidates of the present invention include a modified oligonucleotide sequence obtained by random polymerization of modified nucleotide n-mers (wherein n is an integer) having a modified nucleoside having a substituent introduced therein, and because they are used as are in a mixture (that is, a pool), they may include a wide variety of structures, and because those structures that are likely to bind specifically to the membrane protein can be selected through experience, testing or the like, they are highly likely to include a functional molecule.

When the pool of functional molecule candidates of the present invention is brought into contact with a membrane protein, if a functional molecule containing a modified oligonucleotide sequence that binds specifically to the membrane protein is present in the pool this functional molecule will bind specifically to the membrane protein.

This is explained as shown in FIG. 4 using as an example a membrane protein that passes through the cell membrane multiple times (hereunder, a “membrane protein that passes through the cell membrane multiple times” is called a “multiple transmembrane protein”). FIG. 4 schematically shows the steps by which the functional molecule candidate pool of the present invention is brought into contact with a multiple transmembrane protein 61, the multiple transmembrane protein 61 is treated with a protease and a functional molecule that has bound to the multiple transmembrane protein 61 is isolated. The structural parts folded over as bars represent hydrophobic parts 62, which are connected by loop-shaped parts (hydrophilic parts) 63. In the cell membrane, hydrophobic parts 62 are in the inside (hydrophobic part) of the cell membrane, while loops 63 are exposed outside the cell membrane.

When the functional molecule candidate pool of the present invention is brought into contact with a membrane protein of such a structure, functional molecules 64 in the functional molecule candidate pool bind to the multiple transmembrane protein 61.

Next, non-binding functional molecule candidates and excess functional molecules are removed by washing as necessarys. Such washing can be performed by rinsing with a suitable buffer solution when the multiple transmembrane protein is fixed because it is in the cell membrane for example. When the multiple transmembrane protein is not fixed, washing can be accomplished by using a dialysis membrane to exclude non-binding functional molecule candidates and excess functional molecules from the membrane.

When the resulting multiple transmembrane protein 61 is treated with a protease, the loops 63 are cleaved preferentially, and the functional molecules can then be isolated and collected by treatment such as gel filtration, ultrafiltration, dialysis or the like.

A functional molecule can be prepared in this way. The functional molecule can also be manufactured by using some method to amplify an unmodified molecule corresponding to the functional molecule obtained by isolation, read the sequence of unmodified molecules obtained by the amplification, and then translate the results into the sequence of the functional molecule. In the present invention, an “unmodified molecule corresponding to the functional molecule” is a molecule obtained by removing the modifying group from the functional molecule.

In the present invention, “preparation” means obtaining a molecule in this way by bringing a functional molecule candidate pool into contact with a membrane protein, treating the membrane protein with a protease to isolate a functional molecule that has bound to the membrane protein. The loop part (see Japanese Patent Application 2007-576 (Claims)) which comes with the functional molecule can be easily removed by alkali treatment or other post-treatment, but may be left joined to the functional molecule depending on the use.

In the present invention, “manufacturing” means separately producing the functional molecule according to a sequence translated from the “prepared” functional molecule according to the present invention. In this case, the method of separately producing the molecule is not particularly limited, and known techniques may be applied.

Using the modified nucleotide n-mers of the present invention, there may an extremely large number of functional molecule candidates in the functional molecule candidate pool. This can be easily understood by looking at unmodified nucleotide n-mers.

When unmodified nucleotides consist of deoxyribonucleotides such as DNA, they contain only the four bases adenine (A), thymine (T), guanine (G) and cytosine (C), while when they consist of ribonucleotides such as RNA, they contain only the four bases adenine (A), thymine (T), uracil (U) and cytosine (C) (with thymine being 5-methyluracil). Consequently, these are limited to 16 different combinations. However, the possible base combinations may be greatly increased by introducing those having various modifications in the U base parts and C base parts of the deoxyribonucleotides for example.

Table 1 gives an example of a correspondence table in which unmodified nucleotide n-mers and modified nucleotide n-mers are matched 1:1 as represented by the sequence of n bases of the nucleosides. This means that the combination AC₁ is prepared instead of the combination AC, and a dimer with the combination C₂A is prepared instead of a dimer with the combination CA for example. In this table, 5′ means the 5′ base and 3′ means the 3′ base.

TABLE 1

5′

| 3′ | A | C | G | T |
|---|---|---|---|---|
| A | | C₂A | | U₃A |
| C | AC₁ | C₃C | GC₆ | U₄C |
| G | | C₄G | | U₅G |
| T | AU₁ | C₅T | GU₂ | U₆T |

Such combinations can be obtained by reacting nucleotide monomers (C₁ to C₆) having 6 types of modifiers introduced as the C base part and nucleotide monomers (U₁ to U₆) having 6 types of modifiers introduced as the U base part with nucleotide monomers having the base parts A, T, G and C. Using such a combination, therefore, it is possible to obtain 12×12 different combinations. This correspondence table is explained in more detail below.

Since in the present invention the required amount of membrane protein is only the amount needed for subsequent isolation and amplification, it is not necessary to use a large quantity of membrane protein as in the past. For example, 0.1 to 0.5 mg is sufficient. Because there is no time-consuming antigen inoculation, moreover, the preparation period is greatly reduced.

Since it is normally critical that the functional molecule binds to the hydrophilic part of the membrane protein in order to function as an artificial antibody, the target membrane protein does not necessarily have to be removed from the cell membrane and solubilized. However, solubilization may be advantageous in some cases since it allows the membrane protein to be highly concentrated, and for more rapid binding with the functional molecule. Even in such cases, desolubilization is not a concern because long-term antigen inoculation is not required.

Moreover, functional molecules are selected by a reaction involving no organisms using a wide variety of functional molecule candidates as discussed above but no immune animals, thus avoiding the problems that arise because most membrane proteins are highly conserved among organisms, and when animals are sensitized in an effort to obtain anti-human antibodies,-antibodies often are not obtained due to immune tolerance.

The n in a modified nucleotide n-mer (wherein n is an integer) containing a modified nucleoside with a substituent introduced therein is preferably 2 or more or more preferably 2 to 10 or still more preferably 2 to 3.

If n is less than 2, the ability to recognize the target may not be any greater because the types of modified nucleotides will not differ from the 4 types of nucleotides making up the nucleic acid. If n is 4 or more, deletion and addition of one base which may occur during the process of amplification will be more difficult to distinguish due to base sequence similarity, and since when n is 3 a maximum of 64 different side chains can be introduced, n=3 is sufficient in view of the fact that a wide variety of proteins can be produced from 20 types of amino acids, while an n of 4 or more may not provide corresponding advantages and may only add to the burden of synthesis.

The modified oligonucleotide sequences of the present invention may be deoxyribonucleotides or ribonucleotides, or a mixture of these. In this case, they may be single strands or double strands.

There are no particular limits on the position at which a substituent is introduced in a modified nucleoside in the present invention, which may be selected appropriately according to the object. Examples include the pyrimidine 5 position, the purine 7 position, the purine 8 position, extracyclic amine substitution, 4-thiouridine substitution, 5-bromo substitution, 5-iodo-uracil substitution and the like. Of these, the pyrimidine 5 position, the purine 7 position or the like is preferred from the standpoint of not inhibiting the enzyme reaction during amplification (replication), while the pyrimidine 5 position is preferred from the standpoint of ease of synthesis.

The method of introducing such a substituent into the nucleoside is not particularly limited and may be selected appropriately according to the object, but a desirable example is a method that introduces a substituent R into the 5 position of the pyrimidine base of the nucleoside as represented by the following formula.

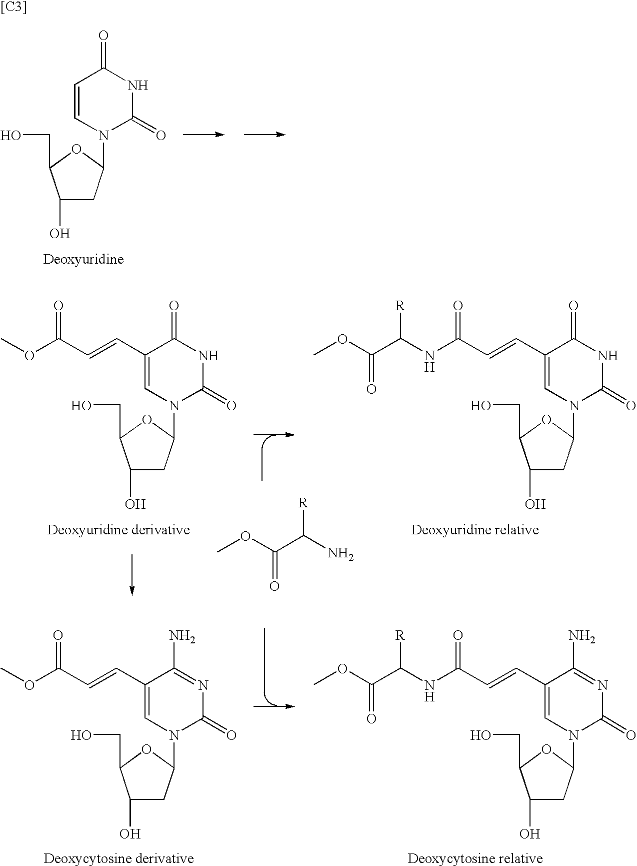

The structures on the right above can be more generally expressed by the formula below (Structural Formula (1)). In Structural Formula (1), P is a pyridine base.

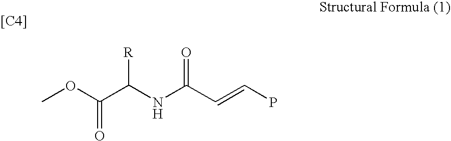

There are no particular limits on substituent R, which may be selected appropriately according to the object. Examples include natural and non-natural amino acids, metal complexes, fluorescent pigments, oxidation-reduction pigments, spin labels, a hydrogen atom, alkyl groups with 1 to 10 carbon atoms and formulae (1) to (10) below:

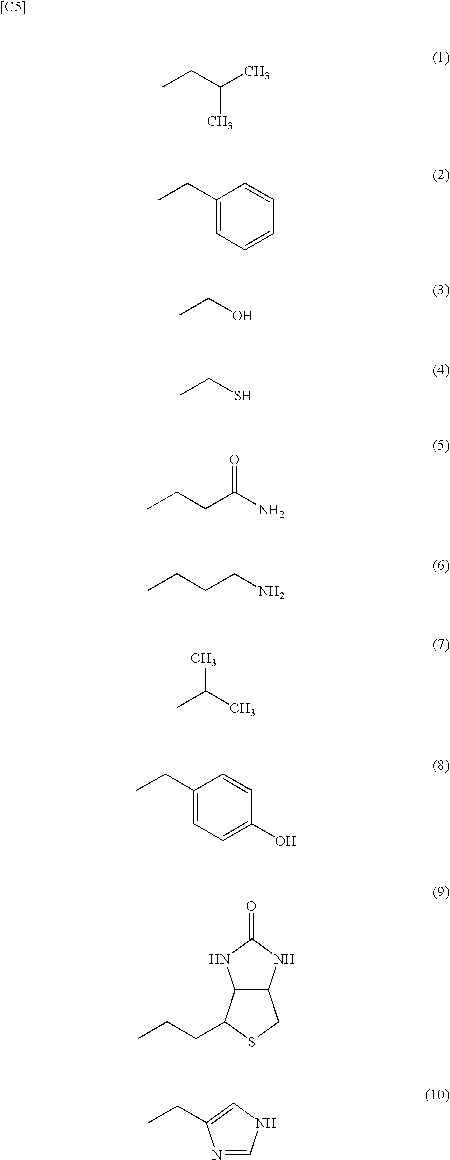

There are no particular limits on the aforementioned natural or non-natural amino acids, which can be selected appropriately according to the object. Examples include, valine, leucine, isoleucine, alanine, arginine, glutamine, lysine, aspartic acid, glutamic acid, proline, cysteine, threonine, methionine, histidine, phenylalanine, tyrosine, tryptophan, asparagine, glycine, serine and the like.

The aforementioned metal complexes are not particularly limited as long as they are compounds with ligands coordinated around metal ions, and may be selected appropriately according to the object. Examples include Ru bipyridyl complexes, ferrocene complexes, nickel imidazole complexes and the like.

The aforementioned fluorescent pigments are not particularly limited and can be selected appropriately according to the object. Examples include the fluorescein family, rhodamine family, eosin family, NBD family and other fluorescent pigments.

The aforementioned oxidation-reduction pigments are not particularly limited and can be selected appropriately according to the object. Examples include leucoaniline, leucoanthocyanin and other leuco pigments and the like.

The aforementioned spin labels are not particularly limited and can be selected appropriately according to the object. Examples include iron N-(dithiocarboxy) sarcosine, TEMPO (tetramethylpiperidine) derivatives and the like.

The aforementioned alkyl groups with 1 to 10 carbon atoms are not particularly limited and can be selected appropriately according to the object. Examples include methyl, ethyl, propyl, isopropyl, butyl, isobutyl, tert-butyl, pentyl, neopentyl, hexyl, cyclohexyl, octyl, nonyl and decyl groups and the like.

These may themselves be substituted with substituents.

The method of synthesizing the aforementioned modified nucleotide dimers is not particularly limited and can be selected appropriately according to the object. Examples include the diester method, triester method, phosphite method, phosphoramidite method, H-phosphonate method, thiophosphite method and the like. Of these, the phosphoramidite method is preferred.

In the phosphoramidite method, the key reaction is generally a condensation reaction between a nucleoside phosphoramidite and a nucleoside using tetrazole as the accelerator. This reaction normally acts competitively on both the hydroxyl groups of the sugar part and the amino groups of the nucleoside base part, but is made to act selectively only on the hydroxyl groups of the sugar part in order to achieve the desired nucleotide synthesis. Consequently, the amino groups are modified with protective groups in order to prevent side reactions. For example, a modified nucleotide dimer (AU1) can be synthesized from deoxyadenosine and a modified deoxyuridine as shown by the following formula.

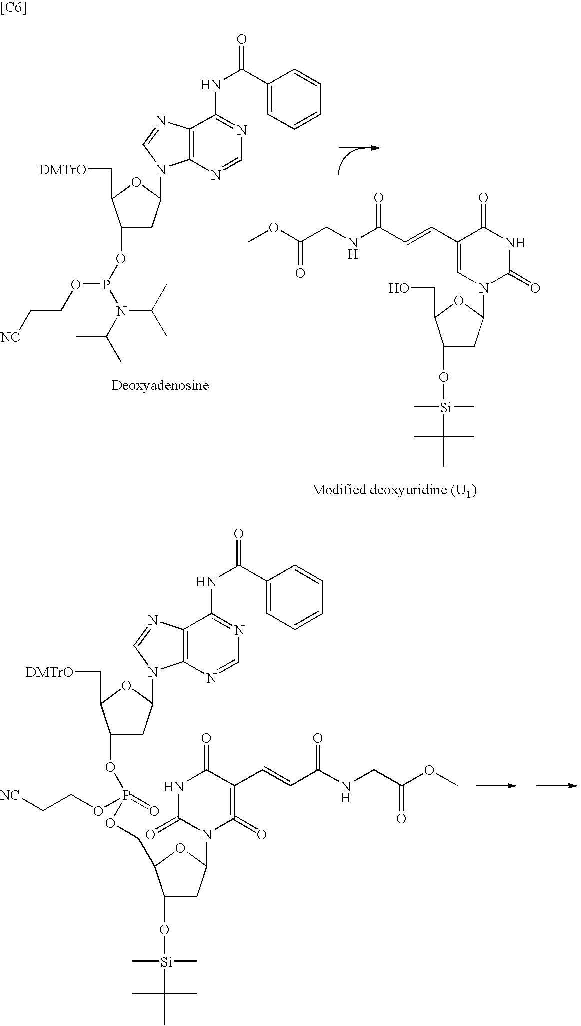

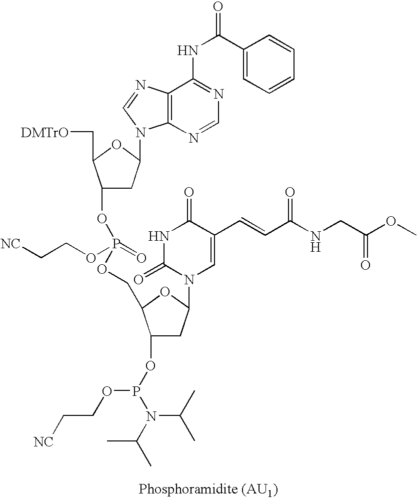

In the formula above, DMTr represents a dimethoxytrityl group.

The other modified nucleotide dimers shown in Table 1 above (AC1, C2A, C3C, C4G, C5T, GC6, AU1, GU2, U3A, U4C, U5G, U6T) can be synthesized by similar methods.

The modified nucleotide dimers synthesized above are matched (associated) 1:1 to unmodified nucleotide dimers.

If there are fewer than 5 types of the aforementioned modified nucleotide dimers, they will not differ greatly from the 4 types of nucleotides making up the nucleic acid, and it may not be possible to sufficiently improve recognition of the target.

An example of such a correspondence table is Table 1 above. In Table 1, the 4 nucleoside bases are arranged horizontally (5′ side) in the order A, C, G, T and are also arranged vertically (3′ side) in the order A, C, G, T, so that these bases correspond 1:1 to form 12 patterns.

Modified nucleotide trimers can also-be used in the same way as the aforementioned nucleotide dimers. Table 2 gives an example of the aforementioned correspondence table in this case. 56 different modified nucleotide trimer patterns are formed in Table 2. Modified nucleotide n-mers (wherein n is an integer) can also be used in the same way as the aforementioned nucleotide dimers and modified nucleotide trimers, and in this case 4n patterns (4n kinds of modified nucleotide n-mers) can be formed on the aforementioned correspondence table.

TABLE 2

| | A | | C | | G | | T | |
|---|---|---|---|---|---|---|---|---|
| A | A | G | A | G | A | G | A | G |
| | | | C₂AA | C₃AG | | | U₃AA | U₄AG |
| | C | T | C | T | C | T | C | T |
| | AAC₁ | AAU₁ | C₄AC | C₅AT | GAC₆ | GAU₂ | U₅AC | U₆AT |
| C | A | G | A | G | A | G | A | G |
| | AC₇A | AC₈G | C₁₁CA | C₁₂CG | GC₁₅A | GC₁₆G | U₇CA | U₈CG |
| | C | T | C | T | C | T | C | T |
| | AC₉C | AC₁₀T | C₁₃CC | C₁₄CT | GC₁₇C | GC₁₈T | U₉CC | U₁₀CT |
| G | A | G | A | G | A | G | A | G |
| | | | C₂₀GA | C₂₁GG | | | U₁₃GA | U₁₄GG |
| | C | T | C | T | C | T | C | T |
| | AGC₁₉ | AGU₁₁ | C₂₂GA | C₂₃GT | GGC₂₄ | GGU₁₂ | U₁₅GC | U₁₆GT |
| T | A | G | A | G | A | G | A | G |
| | AU₁₇A | AU₁₈G | C₂₅TA | C₂₆TG | GU₂₁A | GU₂₂T | U₂₅A | U₂₆TG |
| | C | T | C | T | C | T | C | T |
| | AU₁₉C | AU₂₀T | C₂₇TC | C₂₈TT | GU₂₃C | GU₂₄T | U₂₇TC | U₂₈TT |

In Table 1, there are conditions governing the 12 kinds of modified nucleotide dimers as discussed below.

Specifically, the base sequence is read from the 5′ end to the 3′ end, with the modified nucleotide dimer AC1 corresponding to the base sequence AC. The modified nucleotide dimer AU1 corresponds to the sequence AT. The modified nucleotide dimer C2A corresponds to the base sequence CA. The modified nucleotide dimer C3C corresponds to the base sequence CC. The modified nucleotide dimer C4G corresponds to the base sequence CG. The modified nucleotide dimer C2A corresponds to the base sequence CT. The modified nucleotide dimer GC6 corresponds to the base sequence GC. The modified nucleotide dimer GU2 corresponds to the base sequence GT. The modified nucleotide dimer U3A corresponds to the base sequence TA. The modified nucleotide dimer U4C corresponds to the base sequence TC. The modified nucleotide dimer U5G corresponds to the base sequence TG. The modified nucleotide dimer U6T corresponds to the base sequence TT.

There are no particular limits on the conditions governing the base sequences and modified nucleotide dimers in the correspondence table (Table 1), which can be selected appropriately according to the object, and Table 1 represents only one example. If it proves difficult to prepare 12 types of modified nucleotide dimers, some may be duplicated, but in this case the ability to recognize the target is reduced correspondingly.

In Table 1 above, modified nucleotide dimers have not been prepared from combinations of the same purine base (AA, AG, GA, GG) because the purine base has low reactivity with the enzyme used in modification, but this does not mean that modified nucleotide dimers cannot be prepared from combination of the same purine base.

Based on Table 1, the 4 kinds available with conventional nucleic acids are increased at once to 12 kinds through correspondence with 12 kinds of dimeric modified nucleosides, thus allowing for the ability to recognize many kinds of targets.

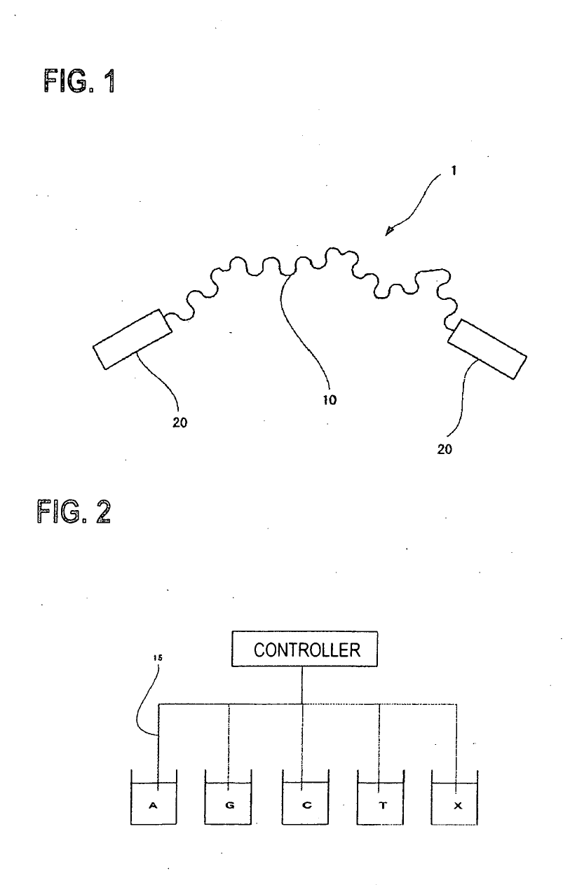

The modified oligonucleotide sequences making up the functional molecule candidate pool of the present invention preferably have fixed oligonucleotide sequences 20, 20 at both ends as shown by a modified oligonucleotide sequence 10 in FIG. 1, because it allows efficient amplification (replication) through binding of primers to the fixed oligonucleotide sequences during PCR in the sequence decoding step. A modified oligonucleotide sequence of the present invention can be thought of as including a modified oligonucleotide sequence 10 and fixed oligonucleotide sequences 20, 20 at both ends thereof. A case wherein functional molecules that are prepared or manufactured contains no fixed oligonucleotide sequences, while the functional molecule candidates have fixed oligonucleotide sequences is also included within the scope of the present invention.

The number of nucleotides in the aforementioned modified oligonucleotide sequences is not particularly limited and can be determined appropriately according to the object, but is preferably 10 to 100 or more preferably 10 to 50. The number of nucleotides in the aforementioned fixed oligonucleotide sequences is also not particularly limited and can be determined appropriately according to the object, but at least 15 is normally preferable and from 20 to 40 is more preferable.

There are no particular limits on the method of preparing the functional molecule candidate pool in the present invention, which can be selected appropriately from known methods according to the object. A method using a DNA synthesizer is preferred.

There are no particular limits on the method using a DNA synthesizer, which can be selected appropriately according to the object. For example a desirable method is one such as that shown in FIG. 2 in which a reagent which is a mixture of multiple types of synthesized modified nucleotide dimers (12 types in the example of FIG. 2, shown by “X” in FIG. 2) synthesized using a DNA synthesizer, is taken up by a nozzle 15 under the control of a controller and polymerized to prepare the functional molecule candidate pool having modified oligonucleotide sequences with any random sequence orders. This method is advantageous because it allows for efficient preparation of the functional molecule candidate pool.

The fixed nucleotide sequences can be synthesized in the same way from the four bases adenine (A), thymine (T), guanine (G) and cytosine (C).

Another way of preparing the functional molecule candidate pool is to align and anneal monomer blocks to previously prepared oligonucleotide random sequences, and join them by application of DNA ligase or RNA ligase to prepare the functional molecule candidate pool. A function molecule candidate pool having modified oligonucleotide sequences with any random sequence orders can also be prepared by this method.

DNA ligase is an enzyme that catalyzes the formation of a covalent bond between the 5′-phosphate and 3′-hydroxyl of adjacent nucleotides. By contrast, RNA ligase is an enzyme that joins a 5′-phosphate terminal polynucleotide to a 3′-hydroxyl terminal polynucleotide. The substrate for RNA ligase is normally RNA, but it can also efficiently join a 5′-phosphate terminal polydeoxyribonucleotide and a polydeoxyribonucleotide having a ribonucleotide only at the 3′ terminal.

The aforementioned functional molecule candidate pool includes the aforementioned modified oligonucleotide sequences, but may also as necessary include sequences obtained by random polymerization of DNA or RNA monomers or oligomers without modification with substituents.

There are no particular limits on the method of bringing the functional molecule candidate pool of the present invention into contact with the membrane protein, and one example is a method in which the membrane protein or a liquid containing the membrane protein is added to the functional molecule candidate pool in a liquid state, or vice versa, and then incubated under appropriate temperature conditions. There are no particular limits on the composition of the functional molecule candidate pool in a liquid state, the composition of the liquid containing the membrane protein, the temperature and other incubation conditions or the incubation time or the like, which can be selected appropriately from known conditions that allow the membrane protein to remain stable. In the case of a histamine H₁ receptor for example, the incubation conditions could be 30 minutes to 24 hours at 37° C. or 25° C. or the like in a solution of 75 mM Tris-HCl (pH 7.4), 12.5 mM MgCl₂ and 1 mM EDTA.

Following incubation, functional molecule candidates not bound to the membrane protein are removed. The functional molecule candidates to be removed may include not only modified oligonucleotide sequences that do not bind to the membrane protein but also functional molecules that have the ability to bind to the membrane protein but did not have the opportunity.

Next, the membrane protein is treated with a protease to isolate functional molecules that have bound to the membrane protein, and in this treatment method the protease or a solution of the protease is simply added to a liquid containing the membrane protein, or vice versa, and functional molecules that have bound to the membrane protein are isolated. This treatment serves to decompose the loop-shaped parts (hydrophilic parts) 63 in FIG. 4 for example to thereby isolate the functional molecules.

There are no particular limits on what protease is used, and a known one may be used. Examples include trypsin, chymotrypsin, elastase, subtilisin and the like. The other components of the protease solution are not particularly limited, which may be selected from known materials as long as it is within the known optimal pH range for the protease, such as pH 7 to 9 in the case of trypsin or pH 7.5 to 8.5 in the case of chymotrypsin. For example, a PBS (phosphate buffered saline), TBS (Tris buffered saline) or other solution composition with the pH adjusted to the optimal pH for the protease is generally used. When using trypsin, it is known that autolysis can be moderated by adding 20 mM CaCl₂ to the reaction solution, resulting in more stable controlled autolysis.

This decomposition step may be monitored by any method if possible. Examples include methods such as MALDI TOF-MASS (Matrix-Assisted Laser Desorption Ionization Time-of-Flight MASS Spectrometry), electrophoresis using a gel matrix, or liquid chromatography.

Once decomposition is verified, an inhibitor of the protease used for decomposition can be added to stop the reaction. When trypsin is used for decomposition for example, a serine protease inhibitor such as phenylmethane sulfonyl fluoride (PMSF) or 4-(2-aminoethyl)-benzenesulfonyl fluoride (AEBSF) can be added to stop the decomposition reaction. However, in some cases it is possible to proceed to the next step without stopping the decomposition reaction.

Next, the functional molecules isolated from the membrane protein are removed. The method in this case is not particularly limited, and a known method can be used. For example, the functional molecules can be removed using an ultrafiltration membrane, or by gel filtration or the like.

The removed functional molecules are useful for manufacturing, functional analysis and the like once their sequence has been decoded. To this end, it is normally necessary to amplify the corresponding unmodified molecules from the isolated functional molecules, decode the sequence of corresponding unmodified molecules obtained by the amplification and translate the results into the sequence of the isolated functional molecules.

The amplification method is not particularly limited, and can be selected appropriately from methods known in the technical field. Examples include PCR (polymerase chain reaction), LCR (ligase chain reaction), 3SR (self-sustained sequence replication), SDA (strand displacement amplification), RT-PCR, ICAN, LAMP and the like. One method can be used alone or two or more may be used. Amplification may be based on the functional molecules themselves, or may be performed after all or some of the modifiers (substituents) have been removed from the functional molecules. A known method such as alkali treatment can be used to remove the modifiers (substituents).

The PCR or polymerase chain reaction method is a method that allows a specific oligonucleotide region to be amplified hundreds of thousands of times by repeating a DNA synthesis reaction using a DNA synthesis enzyme in a test tube. In PCR, the primer elongation reaction is performed by incorporating 4 or 5 kinds of nucleotide triphosphate {deoxyadenosine triphosphate, deoxyguanosine triphosphate, deoxycytidine triphosphate and thymidine triphosphate or deoxyuridine triphosphate (a mixture of which is called dNTP)} into the primers as a substrate.

Amplification reaction reagents including unit nucleic acids and nucleic acid elongation enzymes are normally used in this elongation reaction to amplify the nucleic acid chain. Any DNA polymerase such as E. Coli DNA polymerase I, E. Coli DNA polymerase I Klenow fragment or T4 DNA polymerase can be used as the nucleic acid elongation enzyme in this case, but it is preferable to use a heat-stable DNA polymerase such as Taq DNA polymerase, Tth DNA polymerase or Vent DNA polymerase, thereby eliminating the need to add new enzyme during each cycle and allowing the cycles to repeat automatically, and further allowing the annealing temperature to be set to 50 to 60° C., which increases the specificity of recognition of the target base sequence by the primer, allowing for a rapid and specific gene amplification reaction (see Japanese Patent Application Laid-open No. H01-314965 (Claims), Japanese Patent Application Laid-open No. H01-252300 (Claims)).

Oil can be added to prevent evaporation of the moisture in the reaction solution during the reaction. The oil may be any that is dispersible in water and has a lower specific weight than water, and specific examples include silicon oil and mineral oil. However, there are gene amplification devices that do not require such a medium, and such a gene amplification device can be used for the primer elongation reaction.

In this way, the target oligonucleotide can be efficiently amplified and large quantities of oligonucleotide produced by repeating the elongation reaction using the aforementioned primer. Regarding the conditions and other specific methods used in this gene amplification reaction, examples include the known methods described in Jikken Igaku, Yodosha, 8, No. 9 (1990), PCR Technology Stockton Press, 1989 and other Documents.

PCR converts the aforementioned modified oligonucleotide sequence to an oligonucleotide sequence unmodified by substituents. In the present invention “amplifying the corresponding unmodified molecule from the isolated functional molecule” means amplification as an oligonucleotide sequence unmodified by substituents as explained above.

When the modified oligonucleotide sequence consists of ribonucleotides rather than deoxyribonucleotides, an oligonucleotide sequence consisting of deoxyribonucleotides can be synthesized by a reverse transcription reaction. Reverse transcription is a method of synthesizing deoxyribonucleotides using ribonucleotides as the template, and the reaction liquid and reaction conditions for the reverse transcription reaction differ depending on the ribonucleotides in question. For example, it can be performed by adding RNase-free sterile distilled water and 3′-primer to the ribonucleotide solution, which is then incubated and cooled, after which a reverse transcription buffer containing Tris-HCl, KCl, MgCl₂ and the like is added together with DTT and dNTPs, followed by addition of a reverse transcriptase and incubation. The reverse transcription reaction can be stopped by adjusting the incubation conditions. Reverse transcription can also be accomplished by reverse transcription PCR.

The method of decoding the sequence of corresponding unmodified molecules obtained by the amplification is not particularly limited, and can be selected appropriately from known methods depending on the object, but examples including methods using gene cloning and DNA sequencing (using an automated DNA base sequencer) by the chain terminator method, Sanger method, dideoxy method or the like. One method may be used or two or more may be used.

In the case of genetic cloning, host cells are transformed with an expression vector having the oligonucleotide sequence obtained by amplification incorporated therein, and the transformant is then cultured for the production.

Examples of such expression vectors include plasmid vectors, phage vectors, and chimera vectors of plasmids and phages.

Examples of such host cells include prokaryotic microorganisms such as E. coli and B. subtilis, eukaryotic microorganisms such as yeasts, and animal cells and the like.

The translation step of translating the decoding results into the sequence of the isolated functional molecule is a step of translation of the sequence of corresponding unmodified molecule the base sequence of which has been determined, based on a correspondence table in which unmodified nucleotide n-mers and modified nucleotide n-mers are matched 1:1 as represented by the sequence of n bases of the nucleosides.

This translation is preferably performed based on this correspondence table for each n bases starting from the 5′ end of the sequence of corresponding unmodified molecules (the base sequence of which has been determined). For example, when the modified nucleotide n-mers are modified nucleotide dimers, translation can be based on the correspondence table for each 2 bases starting from the 5′ end of the unmodified oligonucleotide sequence. Specifically, translation is based on the correspondence table represented by Table 1. For example, if the modified oligonucleotide sequence is determined to be “ATGCTCTAGCCCCT”, it can be translated based on the correspondence table and confirmed to be the sequence “AU1GC6U4CU3AGC6C3CC5T” to determine the sequence of the functional molecule. In many cases it is desirable to insert known fixed bases at regular intervals to delineate blocks.

When the modified nucleotide n-mers are modified nucleotide trimers, translation can be based on the correspondence table for each 3 nucleotides starting from the 5′ end of the unmodified oligonucleotide sequence the base sequence of which has been determined. Specifically, translation is based on the correspondence table represented by Table 2 below.

Beyond the modified nucleotide trimer (n≧4), translation can be based on a correspondence table in which modified nucleotide n-mers and unmodified nucleotide n-mers are matched 1:1 as represented by the sequence of n bases of the nucleosides.

The sequence of the functional molecule of the present invention can be decoded by such translation. Consequently, the functional molecule of the present invention can be manufactured based on such decoding. The manufacturing method in this case is not particularly limited, and any known method may be used. For example the phosphoramidite method can be used.

The functional molecule preparation method and manufacturing method of the present invention are little affected by quantitative restrictions and time restrictions. Specifically, only a small quantity of the membrane protein need be prepared as the antigen. For example 0.1 to 0.5 mg is sufficient as discussed above. The preparation time can be greatly reduced. When the membrane protein is embedded in the membrane, it can be used regardless of whether or not it is in a solubilized aqueous solution, and in fact does not need to be solubilized, eliminating the worry that the membrane protein will no longer be soluble after several days. Consequently, follow-up immunization operations are not required and antibodies can be obtained even from membrane proteins that are prone to desolubilize. This method is also rapid because there is no time-consuming antigen inoculation. In addition, the functional molecule is selected by a reaction involving no organisms using a wide variety of functional molecule candidates, thus avoiding the problems that arise because most membrane proteins are highly conserved among organisms, and when animals are sensitized in an effort to obtain anti-human antibodies, antibodies often are not obtained due to immune tolerance. A functional molecule can be manufactured inexpensively and in a large quantity by performing the aforementioned amplification, decoding and translating and then applying known techniques.

The functional molecule of the present invention obtained by the functional molecule preparation or manufacture of the present invention can have affinity and specificity equal to that of an antibody, and can be used favorably in a wide variety of fields. For example, a functional molecule of the present invention obtained by the functional molecule preparation method or manufacturing method of the present invention which has confirmed to be a functional molecule having affinity for a specific membrane protein can be used favorably in the fields of pharmaceuticals and drug delivery.

### EXAMPLES

Examples of the present invention are explained in detail below.

FIG. 4 is a diagram of one example of the present invention. An artificial antibody solution (that is, as the functional molecule candidate pool of the present invention) is added to a solution consisting of a purified membrane protein and a tris buffer solution containing salts, and incubated at room temperature for example. This is then washed with a buffer to remove from the solution non-bound artificial antibodies.

Trypsin is added to the solution, which is then incubated to decompose the loop parts of the membrane protein. The decomposition enzyme need not be trypsin. The progress of decomposition is monitored periodically by MALDI TOF-MASS or the like.

Once decomposition has been confirmed, an inhibitor of the protease used in decomposition is added to stop the reaction. For example, when trypsin has been used for decomposition the decomposition reaction is stopped by adding a serine protease inhibitor such as phenylmethane sulfonyl fluoride (PMSF) or 4-(2-aminoethyl)-benzenesulfonyl fluoride (AEBSF).

Next, the antibody and protein are separated using an ultrafiltration membrane, or by gel filtration. The isolated antibody can be decoded by the method described in Japanese Patent Application Laid-open No. 2004-337022 (Claims) and Japanese Patent Application 2003-576617 (Claims), and the resulting antibody identified.

1. A method for preparing a functional molecule binding specifically to a membrane protein,
said method comprising:
bringing said membrane protein into contact with a pool of functional molecule candidates including a modified oligonucleotide sequence obtained by random polymerization of modified nucleotide n-mers (wherein n is an integer) comprising a modified nucleoside having a substituent introduced therein; and
then treating said membrane protein with a protease to isolate a functional molecule that has bound to said membrane protein.

2. The method for preparing a functional molecule according to claim 1, wherein said membrane protein is a single kind of protein.

3. The method for preparing a functional molecule according to claim 1, wherein said membrane protein is a membrane protein that passes through a cell membrane a plurality of times.

4. The method for preparing a functional molecule according to claim 1, wherein said membrane protein is used as said membrane protein is present in said cell membrane.

5. The method for preparing a functional molecule according to claim 1, wherein the n is 2 or 3.

6. The method for preparing a functional molecule according to claim 1, wherein said modified oligonucleotide sequence includes either a deoxyribonucleotide or ribonucleotide or both.

7. The method for preparing a functional molecule according to claim 1, wherein said substituent is introduced into the 5^{th} position of the pyrimidine base of said nucleoside.

8. The method for preparing a functional molecule according to claim 1, wherein said substituent is selected from the groups represented by the following Structural Formula (I): 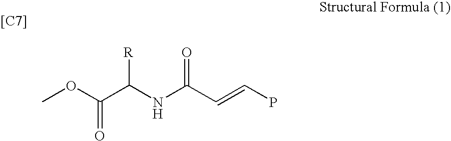
(wherein R is a group selected from natural and non-natural amino acids, metal complexes, fluorescent pigments, oxidation-reduction pigments, spin labels, a hydrogen atom, alkyl groups with 1 to 10 carbon atoms and formulae (1) to (10) below; and P is a pyrimidine base).

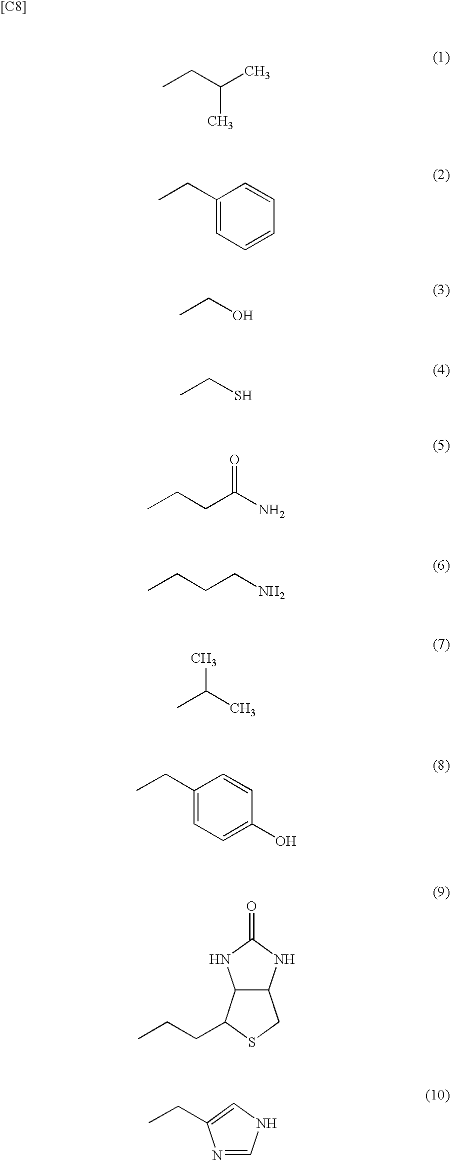

9. The method for preparing a functional molecule according to claim 1, wherein said modified oligonucleotide sequence is synthesized by annealing nucleotide monomers to nucleotide random sequences and linking said nucleotide monomers by means of at least one of a DNA ligase and RNA ligase.

10. The method for preparing a functional molecule according to claim 1, wherein said modified oligonucleotide sequence included in the pool of said functional molecule candidates comprises fixed oligonucleotide sequences at both ends.

11. A functional molecule manufacturing method comprising:
amplifying a corresponding unmodified molecule from a functional molecule prepared by the functional molecule preparation method according to claim 1;
decoding the sequence of corresponding unmodified molecules obtained by the amplification; and
translating said decoding results into the sequence of said functional molecule.

12. The functional molecule manufacturing method according to claim 11, wherein said amplification is performed by any method selected from PCR, LCR, 3SR, SDA, RT-PCR, ICAN and LAMP.

13. A functional molecule manufacturing method according to claim 11, wherein said sequence of corresponding unmodified molecules the base sequence of which has been determined is translated based on a correspondence table in which unmodified nucleotide n-mers and modified nucleotide n-mers are matched 1:1 as represented by the sequence of n bases of the nucleosides.

14. The functional molecule manufacturing method according to claim 13, wherein said translation is performed based on said correspondence table for each n bases starting from the 5′ end of the sequence of said corresponding unmodified molecules the base sequence of which has been determined.

15. The functional molecule manufacturing method according to claim 14, wherein said modified nucleotide n-mers are modified nucleotide dimers.

16. The functional molecule manufacturing method according to claim 14, wherein said modified nucleotide n-mers are modified nucleotide trimers.

17. A functional molecule manufactured by a functional molecule manufacturing method according to claim 11.
